(19) United States
(12) Patent Application Publication
(10) Pub. No.: US 2013/0093692 A1
(43) Pub. Date: Apr. 18, 2013

(54) GESTURE DETECTING METHOD CAPABLE OF FILTERING PANEL MISTOUCH

(71) Applicants: Tsung-Yu Wang, Hsinchu City (TW); Yi-Rong Ko, Hsinchu City (TW); Chih-Chang Lai, Taichung City (TW)

(72) Inventors: Tsung-Yu Wang, Hsinchu City (TW); Yi-Rong Ko, Hsinchu City (TW); Chih-Chang Lai, Taichung City (TW)

(73) Assignee: NOVATEK MICROELECTRONICS CORP., Hsinchu (TW)

(21) Appl. No.: 13/350,826

(22) Filed: Jan. 16, 2012

(30) Foreign Application Priority Data
Oct. 13, 2011 (TW) 100137185

(51) Int. Cl. G06F 3/041

(52) U.S. Cl. 345/173

(57) ABSTRACT

A gesture detecting method capable of filtering a panel mistouch includes following steps is provided. First, an area of a touch region for a touch event on a touch panel is detected. Next, it is determined whether the area of the touch region is greater than a minimum predetermined area value and smaller than a maximum predetermined area value. When a result of the above determination is affirmative, whether a shape of the touch area is a mistouch shape is determined. Finally, when the shape of the touch region is the mistouch shape, a set of touch coordinates is not reported.

### CROSS-REFERENCE TO RELATED APPLICATION

This application claims the priority benefit of Taiwan application serial no. 100137185, filed on Oct. 13, 2011. The entirety of the above-mentioned patent application is hereby incorporated by reference herein and made a part of this specification.

### BACKGROUND OF THE INVENTION

1. Field of the Invention

The invention relates to a gesture detecting method. More particularly, the invention relates to a gesture detecting method capable of filtering panel mistouch.

2. Description of Related Art

Along with development of a multi-touch technique, a projected capacitive touch technique has become one of main streams of the touch panel techniques. Since human body is a good conductor, when the human body approaches to a projected capacitive touch panel, a capacitance generated between a transparent electrode of the projected capacitive touch panel and the human body is varied due to an electrostatic effect. By measuring a capacitance variation of a sensing line on the projected capacitive touch panel, a position of a touch point is determined.

Besides, in the current projected capacitive touch panel, a touch event is generally determined to be triggered by a finger or a palm of the user according to an area size of a continuous press, by the manner a mistouch of the palm may be filtered out and such touch event may be omitted. However, if occurrence of the mistouch is determined only according to the area size of a shape of a touch region, most of mistouch gestures may not be effectively filtered out in actual applications.

In detail, when a user operates the projected capacitive touch panel, although the user generally touches the touch panel through a small-area fingertip, the user is also liable to press the touch panel through a finger pulp to produce a large-area press. Moreover, when the user unintentionally puts the palm on the touch panel, generally, the palm is not totally attached to the touch panel to generate a real large-area press, but only a side part of the little finger or a tendon part of the thumb contacts the touch panel, although these touch areas are greater than the touch area the fingertip, they are not necessarily greater than a touch area of the finger pulp. Therefore, once only the area size of the shape of the touch region is used to determine whether the touch event is triggered by the finger or by the palm, it is hard to accurately determine whether the touch event is a meaningful touch, so that meaningless touches cannot be effectively filtered out, and it is hard to implement a real palm rejection function.

### SUMMARY OF THE INVENTION

A gesture detecting method capable of filtering panel mistouch is provided, by which meaningless touches are effectively filtered to implement a palm rejection function.

A gesture detecting method capable of filtering panel mistouch is provided. In the method, an area of a touch region of a touch event on a touch panel is detected. It is determined whether the area of the touch region is greater than a minimum predetermined area value and smaller than a maximum predetermined area value. When a determination result is affirmative, it is determined whether a shape of the touch region is a mistouch shape. When the shape of the touch region is determined to be the mistouch shape, a set of touch coordinates according to the touch event is not reported.

In an embodiment of the invention, the gesture detecting method capable of filtering panel mistouch further determines whether the area of the touch region is greater than the maximum predetermined area. When a determination result is affirmative, a set of touch coordinates according to the touch event is not reported.

In an embodiment of the invention, the gesture detecting method capable of filtering panel mistouch further determines whether the area of the touch region is smaller than the minimum predetermined area value. When a determination result is affirmative, a set of touch coordinates is reported.

In an embodiment of the invention, the step of detecting the shape of the touch region of the touch event on the touch panel includes detecting blocks with sensing values greater than a sensing threshold along a first direction and a second direction, and a plurality of touch blocks are obtained therefrom. The shape of the touch region is obtained according to a number of the touch blocks.

In an embodiment of the invention, the mistouch shape is substantially a bar shape or an oval shape.

In an embodiment of the invention, the step of determining whether the shape of the touch region is the mistouch shape includes following steps. A first length of the shape of the touch region along a first direction and a second length of the shape of the touch region along a second direction are obtained. It is determined that the shape of the touch region is the mistouch shape when a difference of the first length and the second length is greater than a predetermined difference value.

In an embodiment of the invention, the step of obtaining the first length and the second length includes following steps. A plurality of boundary touch blocks is obtained from the touch blocks of the touch region, where the boundary touch blocks are located at a boundary of the touch region and have a maximum sensing value. The first length is obtained according to a maximum interval of the boundary touch blocks along the first direction, and the second length is obtained according to a maximum interval of the boundary touch blocks along the second direction.

In an embodiment of the invention, the boundary touch blocks include a first boundary touch block, a second boundary touch block, a third boundary touch block and a fourth boundary touch block. The first boundary touch block has a maximum sensing value among the touch blocks located at a boundary side of the touch region along the first direction. The second boundary touch block has a maximum sensing value among the touch blocks located at a boundary side of the touch region along the second direction. The third boundary touch block has a maximum sensing value among the touch blocks located at another boundary side of the touch region along the first direction. The fourth boundary touch block has a maximum sensing value among the touch blocks located at another boundary side of the touch region along the second direction. Moreover, the first length is an interval of the first boundary touch block and the third boundary touch block along the first direction, and the second length is an interval of the second boundary touch block and the fourth boundary touch block along the second direction.

In an embodiment of the invention, an extending direction of the mistouch shape is substantially parallel to one of the first direction and the second direction, and the mistouch shape is substantially a rectangle.

In an embodiment of the invention, the step of determining whether the shape of the touch region is substantially the mistouch shape includes following steps. A plurality of boundary touch blocks is obtained from the touch blocks of the touch region, where the boundary touch blocks are located at a boundary of the touch region and have a maximum sensing value. It is determined whether any boundary touch block deviates from a central position of the corresponding boundary side. When a determination result is affirmative, the shape of the touch region is determined to be the mistouch shape.

In an embodiment of the invention, the step of determining whether any boundary side deviates from the central position of the boundary side includes following steps performed to one or a plurality of the boundary touch blocks. A first individual distance between a first reference boundary touch block on a first boundary side of the touch region and a second reference boundary touch block on another boundary side of the touch region is obtained. A second individual distance between the first reference boundary touch block and a third reference boundary touch block on still another boundary side of the touch region is obtained. It is determined whether a difference between the first individual distance and the second individual distance is greater than an offset threshold. When a determination result is affirmative, it is determined that the first reference boundary touch block on the first boundary side deviates from the central position.

In an embodiment of the invention, the first reference boundary touch block is located at a boundary side along one of the first direction and the second direction, the second reference boundary touch block and the third reference boundary touch block are respectively located at two boundary sides along another one of the first direction and the second direction, and the first and second individual distances are respectively calculated according to the one of the first direction and the second direction.

In an embodiment of the invention, the boundary touch blocks include a first boundary touch block, a second boundary touch block, a third boundary touch block and a fourth boundary touch block. The first boundary touch block has a maximum sensing value among the touch blocks located at a boundary side of the touch region along the first direction. The second boundary touch block has a maximum sensing value among the touch blocks located at a boundary side of the touch region along the second direction. The third boundary touch block has a maximum sensing value among the touch blocks located at another boundary side of the touch region along the first direction. The fourth boundary touch block has a maximum sensing value among the touch blocks located at another boundary side of the touch region along the second direction. Moreover, the first and second individual distances of the first boundary touch block are individual intervals between the first boundary touch block and the second and the fourth boundary touch blocks along the first direction. The first and second individual distances of the second boundary touch block are individual intervals between the second boundary touch block and the first and the third boundary touch blocks along the second direction. The first and second individual distances of the third boundary touch block are individual intervals between the third boundary touch block and the second and the fourth boundary touch blocks along the first direction. The first and second individual distances of the fourth boundary touch block are individual intervals between the fourth boundary touch block and the third and the first boundary touch blocks along the second direction.

In an embodiment of the invention, an extending direction of the mistouch shape is substantially not parallel to the first and second directions, and the mistouch shape is substantially an irregular bar shape or irregular oval shape.

According to the above descriptions, by determining the area size of the touch region and determining whether a length difference of the touch region along different directions is excessive, and determining whether any touch block in the touch region has an offset, the meaningless touch events can be effectively filtered to implement the real palm rejection function.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a flowchart illustrating a gesture detecting method capable of filtering panel mistouch according to an embodiment of the invention.

FIG. 1B is a detailed flowchart of the gesture detecting method capable of filtering panel mistouch of FIG. 1A.

FIG. 2 is a schematic diagram of a sensing array of a touch panel according to another embodiment of the invention.

FIG. 3 is a schematic diagram of a sensing array of a touch panel according to another embodiment of the invention.

FIG. 4 is a schematic diagram of a sensing array of a touch panel according to still another embodiment of the invention.

### DETAILED DESCRIPTION OF DISCLOSED EMBODIMENTS

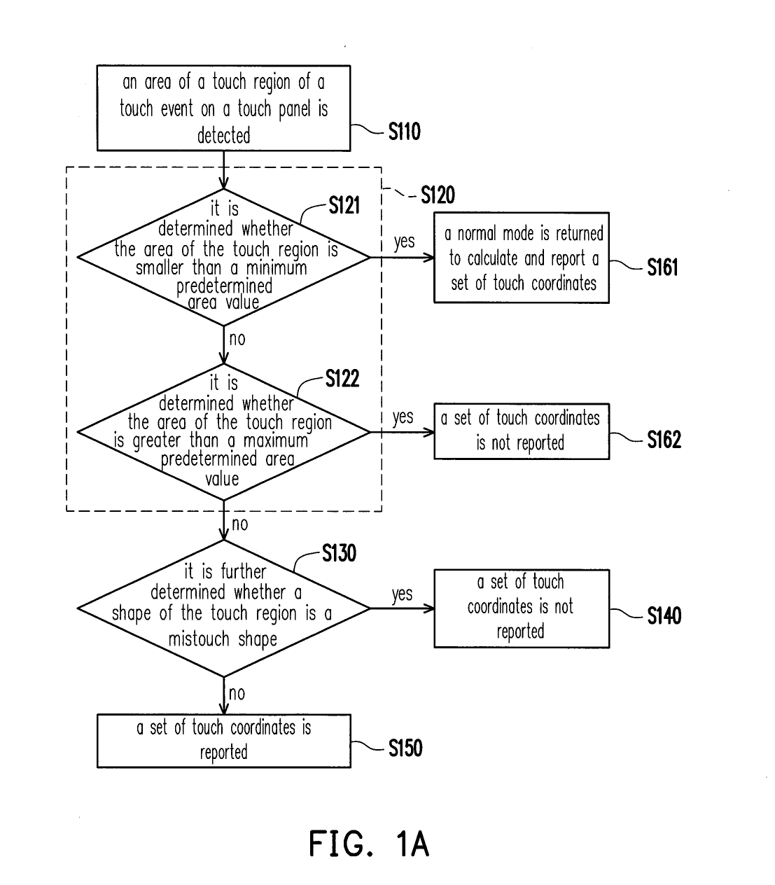

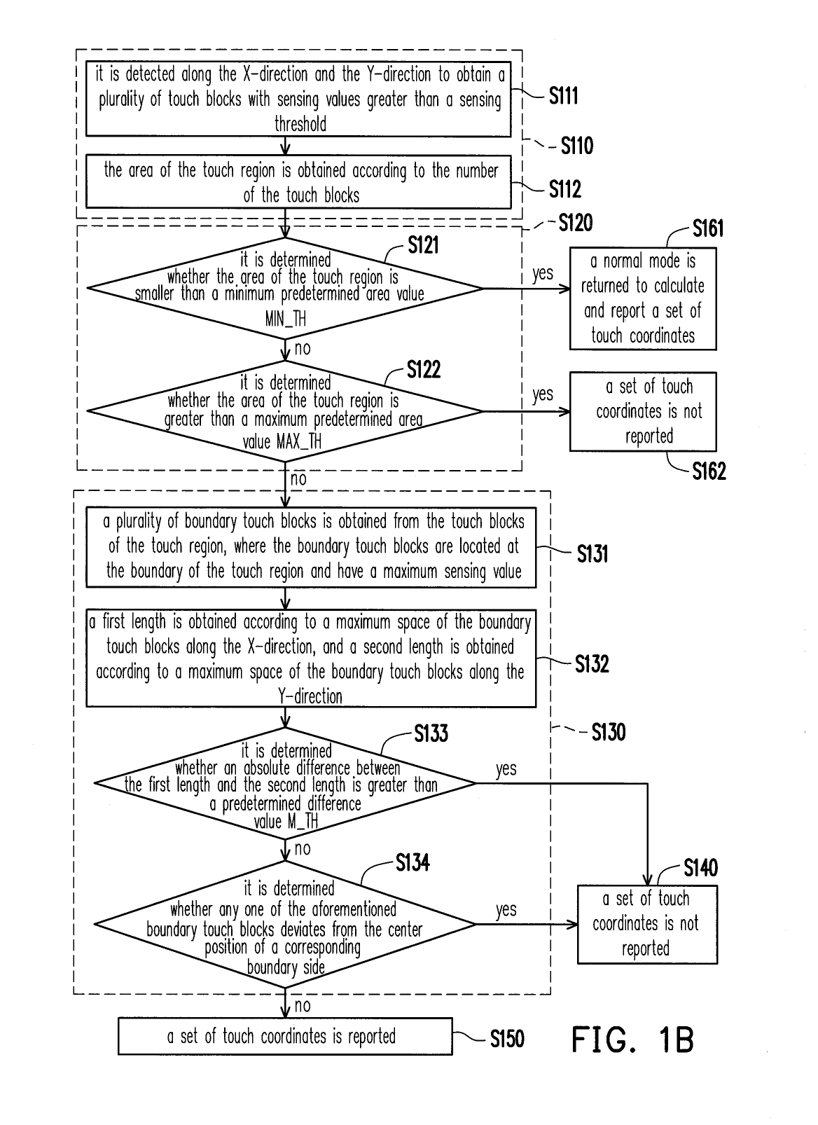

FIG. 1A is a flowchart illustrating a gesture detecting method capable of filtering panel mistouch according to an embodiment of the invention. According to the method, whether a touch event is a meaningful press or a meaningless press is effectively recognized. In the present embodiment, when it is detected that an area of a touch region is within a specific area range, it is further determined whether a shape of the touch region is a mistouch shape. Compared to a conventional technique, besides the meaningless touch events with excessively large or small touch areas that are filtered, other types of meaningless touch events may be filtered according to shapes of the touch regions. Moreover, the gesture detecting method of the embodiment may be applied to various touch panels, for example, capacitive touch panels, resistive touch panels and infrared touch panels, etc.

The so-called meaningless touch may be unintentionally caused by a user, for example, by putting his/her palm on the touch panel in a large area, or contacting the touch panel through a side part of his/her little finger or a tendon part of his/her thumb with a small area, or it may even occur in the case that a large amount of fluid or other objects contact the touch panel. On the other hand, the meaningful press is intentionally caused by the user, for example, by pressing the touch panel through a fingertip or a pressing tool with a small area, or pressing the touch panel through a large-area finger pulp.

Referring to FIG. 1A, a flow of a gesture detecting method capable of filtering panel mistouches in one of the embodiments is schematically illustrated, including the following steps.

First, an area of a touch region of a touch event on a touch panel can be detected (step S110). It is then determined whether the area of the touch region is between a minimum predetermined area value and a maximum predetermined area value (step S120). One embodiment of the determination is shown in steps S121 and 122. In the embodiment, it is determined whether the area of the touch region is smaller than the minimum predetermined area value (step S121), and then determined whether the area of the touch region is greater than the maximum predetermined area value (step S122). However, in other embodiments, the sequence of the steps S121 and S122 may be exchanged, or the steps S121 and S122 may be simultaneously performed.

If the determination result of the step S121 is affirmative, it represents that the area of the touch region is smaller than the minimum predetermined area value. In other words, the touch event has a small touch area, which is probably caused by the user who contacts the touch panel through a small-area fingertip or pressing tool, so the touch event can be directly determined as a meaningful touch. Accordingly, the process returns to a normal mode to calculate and report a set of touch coordinates (step S161). On the contrary, if the determination result of the step S121 is negative, a step S122 is executed, by which it is determined whether the area of the touch region is greater than the maximum predetermined area value.

If a determination result of the step S122 is affirmative, the area of the touch region is greater than the maximum predetermined area value, which represents that the area of the touch region is excessively large. Since a large-area touch is probably caused by a situation that the user unintentionally puts the palm on the touch panel, such touch event may be directly determined as a meaningless touch, and a set of touch coordinates is not reported (step S162). On the contrary, if the determination result of the step S122 is negative, the area of the touch region is neither sufficiently small nor excessively large, and it is further determined whether a shape of the touch region is a mistouch shape (S130).

When the shape of the touch region is a mistouch shape, it also represents that the touch event is the meaningless touch, which is probably caused by the user who unintentionally touches the touch panel through a side part of the little finger or a tendon part of the thumb, so a set of touch coordinates corresponding to the touch event is not reported (step S140). On the contrary, when the shape of the touch region is not a mistouch shape, it represents that the touch event is a meaningful touch, which is, for example, caused by the user who touches the touch panel through a finger pulp, so a set of touch coordinates corresponding to the touch event is reported (step S150).

In other words, in the present embodiment, the step S120 is used to filter the meaningless touch events with excessively large or excessively small touch areas, and the step S130 is used to further determine whether the shape of the touch region is a mistouch shape, so as to filter more types of the meaningless touch events. Therefore, compared to the conventional technique, the present embodiment can effectively filter more types of the meaningless touch events.

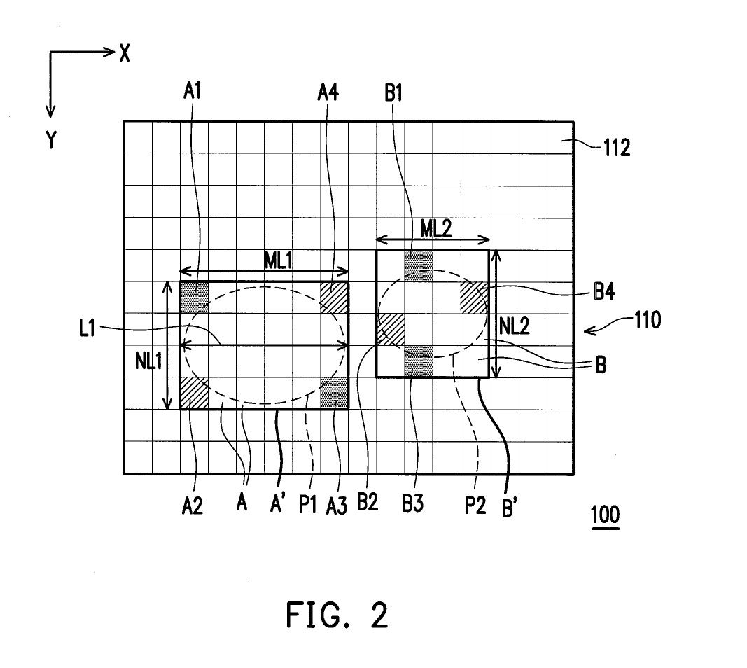

FIG. 1B is a detailed flowchart illustrating the gesture detecting method capable of filtering panel mistouches according to an embodiment of the invention, in which detailed steps of the flow of FIG. 1 are illustrated. FIG. 1B is described in reference to FIG. 2 to FIG. 4, which illustrate several types of the mistouch shape.

Referring to FIG. 2 to FIG. 4, the touch panel 100 includes a plurality of sensing units 112, which can be, for example, arranged as an 11×16 sensing array 110, though the invention is not limited thereto. In the present embodiment, each of the sensing units 112 may provide a sensing value, which can be, for example, raw data output by touch sensors (not shown) on the touch panel 100.

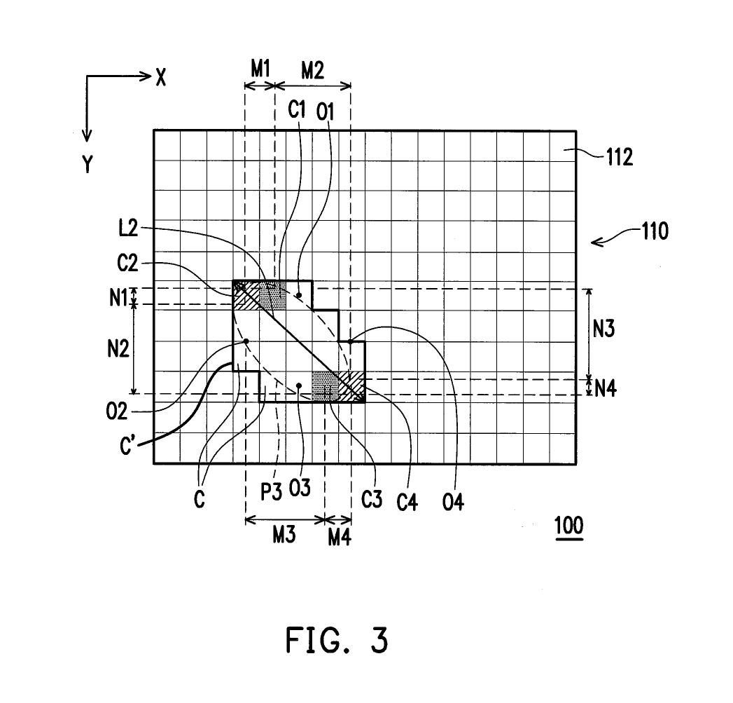

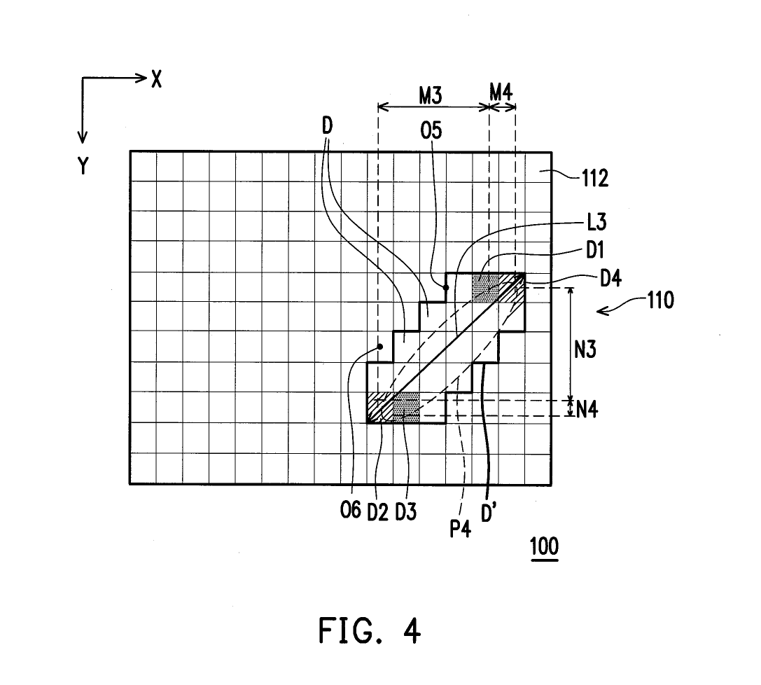

When the user touches the sensing array 110 through a palm tendon to produce a touch point (fore example, P1 or P2 in FIG. 2, or P3 in FIG. 3 and P4 in FIG. 4), sensing values of blocks covered by the touch point are respectively greater than a sensing threshold. Therefore, when a sensing value of a certain sensing unit 112 is detected to be greater than the sensing threshold, it is determined that the block corresponding to the sensing unit 112 is touched. Hereafter, such a block is defined as a touch block, and a region formed by all of the touch blocks is defined as a touch region.

In FIG. 2, a touch region A′ caused by a meaningless press of the touch panel 100 is illustrated. Moreover, a touch region B′ caused by a meaningful press is also illustrated in FIG. 2 for comparing with the touch region A′. FIG. 3 and FIG. 4 are respectively schematic diagrams of touch regions C′ and D′ caused by meaningless presses of the touch panel 100 in two other cases. As described above, the touch regions A′, C′ and D′ probably occur in situations where the user unintentionally touches the touch panel 100 through a side part of the little finger or a tendon part of the thumb. On the other hand, the touch region B′ is probably caused by the user who intentionally presses the touch panel 100 through a finger pulp.

According to FIG. 2, in the embodiment, a shape of the touch region A′ is a bar-shape, which represents that a certain difference exists between a length ML1 thereof along an X-direction and a length NL1 thereof along a Y-direction. In detail, it is observed that an extending direction L1 of the bar-shape touch region A′ is approximately along the X-direction, and edges of the touch region A1 are more regular. The shape of the touch region A1 is close to a rectangle. It should be noted that in other embodiments, the touch blocks corresponding to the meaningless press similar to the touch region A′ may substantially extend along the Y-direction.

Comparatively, a shape of the touch region B′ is close to a square due to similar length and width thereof, and the touch region B′ does not have an obvious extending direction. A reason thereof is that a difference between a length and a width of the finger pulp is small, so that regardless how the finger pulp presses the touch panel 100, a length ML2 of the touch region B′ along the X-direction is similar to a length NL2 of the touch region B′ along the Y-direction. On the other hand, boundary touch blocks B1-B4 the are most heavily pressed (each having a maximum sensing value) on the top, left, bottom and right boundary sides of the touch region B′ are close to respective central positions (not shown) of the four boundary sides.

In addition, referring to FIG. 3 and FIG. 4, the touch regions C′ and D′ are similar to the touch region A′ of FIG. 2 and all have a bar shape, and a difference there between is that extending directions L2 and L3 of the touch regions C′ and D′ deviate from the X-direction and the Y-direction, and the touch regions C′ and D′ have edges that are more irregular. Due to the above difference, the length of the touch region C′ or D′ along the X-direction and the length of that along the Y-direction are close to each other. However, since the extending directions touch regions C′ and D′ are different to that of the touch region B′, the most heavily pressed positions are different. In the touch region C′, boundary touch blocks C1-C4 are the most heavily pressed places on the four boundary sides which have central positions O1 to O4, respectively. The boundary touch block C2 obviously deviates from the central position O2, and the boundary touch block C4 obviously deviates from the central position O4. The most heavily pressed boundary touch blocks D1-D4 on the four boundary sides of the touch region D′ also have the similar deviations.

According to the above features, in the determination on whether a shape of a touch region is a mistouch shape or not, by detecting whether a difference of the lengths of the touch region along the X-direction and the Y-direction is greater than a predetermined value, it can be determined whether the shape of the touch region belongs to a shape type of the touch region A′ of FIG. 2. On the other hand, by analysing deviations of the most heavily pressed points on the boundary sides of the touch region, it can be determined whether the shape of the touch region belongs to a shape type of the touch region C′ or D′ of FIG. 3 or FIG. 4. In a case that neither of the above two determinations are deduced, it can be determined that the shape of the touch region belongs to a shape type of the touch region B′ of FIG. 2. After it is determined whether the shape of the touch region is a mistouch shape, it may be deduced that whether such touch event is a meaningful touch so that a set of touch coordinates for the touch event is required to be reported, or a meaningless touch which does not require reporting of the touch coordinates.

Then, referring to FIG. 1B and FIG. 2 to FIG. 4, the gesture detecting method of FIG. 1B is described below in reference to FIG. 2 to FIG. 4.

In step S110, an area of a touch region corresponding to a touch event on the touch panel 100 is detected. In the present embodiment, the step S110 includes a step S111 and a step S112. It is detected along the X-direction and the Y-direction to obtain a plurality of touch blocks with sensing values greater than a sensing threshold (the step S111), for example, touch blocks A and B shown in FIG. 2, and touch blocks C and D respectively shown in FIG. 3 and FIG. 4. Then, the area of the touch region is obtained according to the number of the touch blocks (the step S112). For example, an area of the touch region A′ is obtained according to the number of the touch blocks A, and the areas of the touch regions B′ to D′ are deduced by analogy. In the exemplary embodiments shown in FIG. 2 to FIG. 4, the touch regions A′, B′, C′ and D′ are respectively composed of 24 touch blocks A, 16 touch blocks B, 16 touch blocks C and 18 touch blocks D.

It can then be determined whether the area of the touch region is smaller than a minimum predetermined area value MIN_TH and greater than a maximum predetermined area value MAX_TH (the step S120). In the embodiment of FIG. 1B, it is first determined whether the area of the touch region is smaller than the minimum predetermined area value MIN_TH (the step S121). If the determination result thereof is affirmative, it represents that such touch is a small-area meaningful touch. Then the process returns to the normal mode and the set of touch coordinates for the touch event is calculated and reported (the step S161). Otherwise, it is then determined whether the area of the touch region is greater than the maximum predetermined area value MAX_TH (step S122).

If the determination result of the step S122 is affirmative, it represents that such touch is a large-area meaningless touch. Therefore, the touch panel stops reporting the touch coordinates (step S162). On the contrary, if the determination result of the step S122 is negative, it is further determined whether a shape of the touch region is a mistouch shape (S130).

It should be noted that after the step S120, the large-area meaningless touch events can be filtered without reporting the touch coordinates, and the small-area meaningful touch events are determined and the corresponding set of the touch coordinates is reported. However, regarding the exemplary embodiments of the touch regions A′ to D′ of FIG. 2 to FIG. 4, since the areas thereof are all between the minimum predetermined area value and the maximum predetermined area value, the step S130 is sequentially performed.

In the embodiment of FIG. 1B, the step S130 for the mistouch shape determination includes steps S131 to S134. The step S131 is mainly used to detect the most heavily pressed boundary touch blocks on the boundary. The steps 132 and S133 are mainly used to filter the meaningless presses similar to the type shown as the touch region A′ at the left side of FIG. 2. The step S134 is mainly used to filter the meaningless presses similar to the type shown as the touch regions C′ and D′ in FIG. 3 and FIG. 4. Finally, the meaningful press shown as the touch region B′ at the right side of FIG. 2 is not filtered. The above steps are introduced in detail below.

In the step S131, a plurality of boundary touch blocks are obtained from the touch blocks of the touch region, where the boundary touch blocks are located at the boundary of the touch region and have a maximum sensing value. In the touch region A′ of FIG. 2, the boundary touch blocks are A1-A4, and in the touch region B′, the boundary touch blocks are B1-B4. Similarly, the touch region C′ includes the boundary touch blocks C1-C4, and the touch region D′ includes the boundary touch blocks D1-D4.

In detail, among the plural touch blocks A of FIG. 2, the boundary touch block A2 is the one which has the maximum sensing value at a left boundary side of the touch region A′ along the X-direction, the boundary touch block A4 is the one which has the maximum sensing value at a right boundary side of the touch region A′ along the X-direction, the boundary touch block A3 is the one which has the maximum sensing value at a bottom boundary side of the touch region A′ along the Y-direction, and the boundary touch block A1 is the one which has the maximum sensing value at a top boundary side of the touch region A′ along the Y-direction.

Similarly, regarding the touch region B′, the boundary touch blocks on the left and right boundary sides along the X-direction are respectively B2 and B4. The boundary touch blocks on the top and bottom boundary sides along the Y-direction are respectively B1 and B3. Similarly, regarding the touch region C′ of FIG. 3, the boundary touch blocks on the left and right boundary sides along the X-direction are respectively C2 and C4, and the boundary touch blocks on the top and bottom boundary sides along the Y-direction are respectively C1 and C3. Regarding the touch region D′ of FIG. 4, the boundary touch blocks on the left and right boundary sides along the X-direction are respectively D2 and D4, and the boundary touch blocks on the top and bottom boundary sides along the Y-direction are respectively D1 and D3.

In order to clearly describe the other steps, coordinates of each of the boundary touch blocks (for example, A1, B1, C1 and D1) on the top boundary side along the Y-direction in the touch regions A′-D′ are defined as (XR, Ymax). Coordinates of each of the boundary touch blocks (for example, A3, B3, C3 and D3) on the bottom boundary side are defined as (XF, Ymin). Moreover, coordinates of each of the boundary touch blocks (for example, A2, B2, C2 and D2) on the left boundary side along the X-direction are defined as (Xmin, YF). Coordinates of each of the boundary touch blocks (for example, A4, B4, C4 and D4) on the right boundary side are defined as (Xmax, YR).

After the step S131, the step S132 is executed, by which a first length is obtained according to a maximum interval of the boundary touch blocks along the X-direction, and a second length is obtained according to a maximum interval of the boundary touch blocks along the Y-direction.

Regarding the touch region A′, the first length ML1 is obtained according to the maximum interval of the boundary touch blocks A1-A4 along the X-direction, and the second length NL1 is obtained according to the maximum interval of the boundary touch blocks A1-A4 along the Y-direction. Therefore, the first length ML1 along the X-direction may be an interval between the left and right boundary touch blocks A2 and A4 along the X-direction, i.e. ML1=(Xmax−Xmin), and the second length NL1 along the Y-direction may be an interval between the top and bottom boundary touch blocks A1 and A3 along the Y-direction, i.e. NL1=(Ymax−Ymin).

Similarly, regarding the touch region B′, the first length ML2 along the X-direction may be an interval between the boundary touch blocks B2 and B4 on the left and right boundary sides along the X-direction, i.e. ML2=(Xmax−Xmin), and the second length NL2 along the Y-direction may be an interval between the boundary touch blocks B1 and B3 on the top and bottom boundary sides along the Y-direction, i.e. NL2=(Ymax−Ymin). The touch regions C′ and D′ of FIG. 3 and FIG. 4 may be deduced by the aforesaid manner, and the first length and the second length are no longer indicated in the figures.

The step S133 is executed to determine whether an absolute difference between the first length and the second length is greater than a predetermined difference value M_TH. If the determination result of the step S133 is affirmative, the touch coordinates are not reported (step S162). Otherwise, the step S140 is executed.

Regarding the touch region A′, since the difference between the first length ML1 and the second length NL1 is great enough, i.e. |(ML1−ML2)|=|(Xmax−Xmin)−(Ymax−Ymin)|>M_TH, the touch event is determined to be a meaningless press, and the touch coordinates are not reported. However, regarding the touch regions B′, C′ and D′, as |(ML1−ML2)|=|(Xmax−Xmin)−(Ymax−Ymin)|≦M_TH, determination of the step S134 is required.

It should be noted that after the comparison of the difference of the first length and the second length in step S133 is completed, the meaningless presses similar to the touch region A′ are filtered, which is, for example, a meaningless press caused by the user who unintentionally touches the touch panel 100 through a side part of the little finger or a tendon part of the thumb.

When the determination result of the step S133 is negative, the step S134 is performed to filter an event where the mistouch shape is an irregular bar shape as shown in FIG. 3 or FIG. 4. When the step S134 is performed, it is determined whether any one of the aforementioned boundary touch blocks deviates from the central position of the corresponding boundary side (the step S134). If the determination result thereof is affirmative, the touch coordinates are not reported (the step S140). Otherwise, the step S150 is executed, by which the touch coordinates of the boundary touch block are calculated and reported.

It should be noted that in the step S134, a plurality of (n) boundary sides are detected to determine whether any one of the n boundary sides has a boundary touch block deviating from the central position. Preferably, as long as any one of the boundary sides has a boundary touch block deviating from the central position, the touch region is determined to have a mistouch shape. The number “n” is preferably set to be greater than or equal to 2. For example, the top boundary side and the left boundary side may be detected, or the other two neighbouring boundary sides may be detected. In other embodiments, “n” may be set to 3, 4 or other integers, as designed.

In an exemplary embodiment, a method of determining whether a boundary side (which is referred to as a first boundary side) has a boundary touch block deviating from the central position includes following steps. A first individual distance between a first reference boundary touch block on the first boundary side and a second reference boundary touch block on a second boundary side is obtained. A second individual distance between the first reference boundary touch block and a third reference boundary touch block on a third boundary side is also obtained. It is determined whether an absolute difference between the first individual distance and the second individual distance is greater than an offset threshold. When the absolute difference is greater than the offset threshold, it represents that the first reference boundary touch block on the first boundary side deviates from the central position of the first boundary side. Otherwise, the first reference boundary touch block is determined not to deviate from the central position.

It should be noted that one or a plurality of the boundary sides can be detected in the above step. In other words, different boundary sides may be selected as the first boundary side for detection. When the first boundary side is one of the boundary sides (for example, one of the left boundary side and the right boundary side) along a first direction (for example, the X-direction), the second and the third boundary sides are two boundary sides (for example, the top boundary side and the bottom boundary side) along a second direction (for example, the Y-direction), and the first and the second individual distances are all calculated along the second direction (for example, the Y-direction). On the contrary, when the first boundary side is one of the boundary sides (for example, one of the top boundary side and the bottom boundary side) along the second direction (for example, the Y-direction), the second and the third boundary sides are two boundary sides (for example, the left boundary side and the right boundary side) along the first direction (for example, the X-direction), and the first and the second individual distances are all calculated along the first direction (for example, the X-direction).

The touch region C′ of FIG. 3 is taken as an example for describing the above detection step. The top boundary side of the touch region C′ is detected, and a first individual distance between the boundary touch block C1 on the top boundary side and the boundary touch block C2 on the left boundary side is obtained. In other words, the first individual distance M1 is an interval between the boundary touch block C1 and the boundary touch block C2 along the X-direction, i.e. M1=(XR−Xmin) Moreover, a second individual distance between the boundary touch block C1 and the boundary touch block C4 on the right boundary side is obtained. In other words, the second individual distance M2 is an interval between the boundary touch block C1 and the boundary touch block C4 along the X-direction, i.e. M2=(Xmax−XR). It is determined whether an absolute difference between the first individual distance M1 and the second individual distance M2 is greater than an offset threshold C_TH. When the determination result is affirmative (i.e. |M1−M2|>C_TH), it is determined that the boundary touch block C1 on the top boundary side deviates from the central position O1 of the top boundary side. Otherwise, the boundary touch block C1 does not deviate from the central position O1.

Similarly, the left boundary side of the touch region C′ may be detected. A first individual distance between the boundary touch block C2 on the left boundary side and the boundary touch block C1 on the top boundary side is obtained. In other words, the first individual distance N1 is an interval between the boundary touch block C2 and the boundary touch block C1 along the Y-direction, i.e. N1=(Ymax−YF). Moreover, a second individual distance between the boundary touch block C2 and the boundary touch block C3 on the bottom boundary side is obtained. In other words, the second individual distance N2 is an interval between the boundary touch block C2 and the boundary touch block C3 along the Y-direction, i.e. N2=(YF−Ymin). It is then determined whether an absolute difference between the first individual distance N1 and the second individual distance N2 is greater than the offset threshold C_TH. When the determination result is affirmative (i.e. |N1−N2|>C_TH), it is determined that the boundary touch block C2 on the left boundary side deviates from the central position O2 of the left boundary side. Otherwise, the boundary touch block C2 does not deviate from the central position O2.

Deduced in a similar manner, the bottom boundary side of the touch region C′ is detected to obtain the first and the second individual distances M3=(XF−Xmin) and M4=(Xmax−XF), and the absolute difference value of the first and the second individual distances M3 and M4 (i.e., |M3−M4|) is calculated for comparing to the offset threshold C_TH, so as to determine whether the boundary touch block C3 deviates from the central position O3. Similarly, the right boundary side of the touch region C′ is detected to obtain the first and the second individual distances N3=(Ymax−YR) and N4=(YR−Ymin), and the absolute difference value of the first and the second individual distances N3 and N4 (i.e., |N3−N4|) is calculated for comparing to the offset threshold C_TH, so as to determine whether the boundary touch block C4 deviates from the central position O4. For sake of simplicity, details thereof are not repeated.

It should be noticed that it is determined whether at least two of the boundary touch blocks in the boundary touch blocks C1-C4 deviate from the respective central positions of the corresponding boundary sides. For example, it is at least determined whether the boundary touch blocks C1 and C2 deviate from the central positions O1 and O2 of the top boundary side and the left boundary side, and as long as one of the boundary touch blocks C1 and C2 has the deviation, it is determined that the touch region C′ has the mistouch shape. Alternatively, it is determined whether each of the boundary touch blocks C1-C4 deviates from the central positions O1-O4 of the corresponding boundary sides, and as long as any of the boundary touch blocks has the deviation, it is determined that the touch region C′ has the mistouch shape.

Referring to FIG. 4, according to the similar method, the steps of detecting deviation of the boundary touch blocks are performed in allusion to the touch region D′. The top boundary side of the touch region D′ is detected to obtain a first individual distance M3=(XR−Xmin) between the boundary touch region D1 and the boundary touch region D2 on the left boundary side along the X-direction, and a second individual distance M4=(Xmax−XR) between the boundary touch region D1 and the boundary touch region D4 on the right boundary side along the X-direction, and the absolute difference value of the first and the second individual distances M3 and M4 (i.e., |M3−M4|) is calculated for comparing to the offset threshold C_TH, so as to determine whether the boundary touch block D1 deviates from the central position O5.

Similarly, the left boundary side of the touch region C′ can be detected to obtain the first and the second individual distances N3=(Ymax−YF) and N4=(YF−Ymin) respectively between the boundary touch block D2 and the boundary touch blocks D1 and D3 on the top and the bottom boundary sides, and the absolute difference value of the first and the second individual distances N3 and N4 (i.e., |N3−N4|) is calculated for comparing to the offset threshold C_TH, so as to determine whether the boundary touch block D2 deviates from the central position O6. The similar detection steps may be performed in allusion to the boundary touch block D3 on the bottom boundary side and the boundary touch block D4 on the right boundary side, and details thereof are not repeated.

In an embodiment, it is determined whether at least two of the boundary touch blocks (for example, the boundary touch blocks D1 and D2) in the boundary touch blocks D1−D4 deviate from the central positions (i.e. the central positions O5 and O6) of the corresponding boundary sides (i.e. the top boundary side and the left boundary side). Alternatively, it may be determined whether each of the boundary touch blocks C1-C4 deviates from the central positions O1-O4 of the corresponding boundary sides. In these two cases, as long as the boundary touch block deviates on any of the boundary sides, it is determined that the touch region D′ has the mistouch shape.

Regarding the touch region B′, the step S134 may also be performed. As shown in FIG. 2, none of the boundary touch blocks on the detected boundary sides deviates from the corresponding central position, so that the touch region B′ does not have the mistouch shape, and the touch coordinates are calculated and reported (the step S150).

On the contrary, regarding the touch regions C′ and D′, according to the step S134, it is determined that the boundary touch block on the detected boundary side deviates from the central position, to that both of the touch regions C′ and D′ are determined to have the mistouch shape, and the touch coordinates are not reported (the step S140).

In other words, in the step S130, the step S133 is performed to filter a part of the meaningless presses similar to the touch region A′ of FIG. 2, and then the step S134 is performed to determine whether the boundary touch blocks have deviation, so as to filter another part of the meaningless presses similar to the touch regions C′ and D′ of FIG. 3 and FIG. 4. As a result, only the touch event having the touch region similar to the touch region B′ of FIG. 2 is determined to be a meaningful press, which requires reporting of the touch coordinates.

When the step S150 is performed, the boundary touch blocks are used to calculate and the report the touch coordinates. The touch coordinates may be coordinates of a central point of the touch area. Taking the touch region C′ as an example, the coordinates of the boundary touch blocks C1-C4 are used to calculate the coordinates of the central point of the touch region C′ to output as the touch coordinates. The touch region D′ can be calculated according to the same method.

In summary, in the embodiment of the invention, it is determined whether a shape of a touch region with a specific area range is a mistouch shape, so that compared to the conventional technique, besides the meaningless touch events with excessively large or small touch areas that are filtered, more types of the meaningless touch events can be further filtered. Moreover, by determining whether a length difference of the touch region along different directions is excessively large, and detecting whether the boundary touch block on any of the boundary sides of the touch region deviates from the corresponding central position, different types of the meaningless touch events can be accurately determined, so as to effectively filter mistouch events.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A gesture detecting method capable of filtering panel mistouch, comprising:
detecting an area of a touch region of a touch event on a touch panel;
determining whether the area of the touch region is greater than a minimum predetermined area value and smaller than a maximum predetermined area value;
determining whether a shape of the touch region is a mistouch shape when a determination result is affirmative; and
when the shape of the touch region is determined to be the mistouch shape, a set of touch coordinates corresponding to the touch event being not reported.

2. The gesture detecting method capable of filtering panel mistouch as claimed in claim 1, further comprising:
determining whether the area of the touch region is greater than the maximum predetermined area value; and
reporting the set of touch coordinates corresponding to the touch event when a determination result is affirmative.

3. The gesture detecting method capable of filtering panel mistouch as claimed in claim 1, further comprising:
determining whether the area of the touch region is smaller than the minimum predetermined area value; and
not reporting the set of touch coordinates corresponding to the touch event when a determination result is affirmative.

4. The gesture detecting method capable of filtering panel mistouch as claimed in claim 1, wherein the step of detecting the area of the touch region of the touch event on the touch panel comprises:
obtaining a plurality of touch blocks with sensing values greater than a sensing threshold; and
obtaining the area of the touch region according to a number of the touch blocks.

5. The gesture detecting method capable of filtering panel mistouch as claimed in claim 1, wherein the mistouch shape is substantially a bar shape.

6. The gesture detecting method capable of filtering panel mistouch as claimed in claim 5, wherein an extending direction of the bar shape is substantially parallel to one of a first direction and a second direction, and the bar shape is substantially a rectangle.

7. The gesture detecting method capable of filtering panel mistouch as claimed in claim 5, wherein an extending direction of the bar shape is substantially not parallel to a first direction and a second direction, and the bar shape has an irregular edge.

8. The gesture detecting method capable of filtering panel mistouch as claimed in claim 1, wherein the step of determining whether the shape of the touch region is the mistouch shape comprises:
obtaining a first length of the shape of the touch region along a first direction and a second length of the shape of the touch region along a second direction; and
determining the shape of the touch region to be the mistouch shape when an absolute difference of the first length and the second length is greater than a predetermined difference value.

9. The gesture detecting method capable of filtering panel mistouch as claimed in claim 8, wherein the step of obtaining the first length and the second length comprises:
obtaining a plurality of boundary touch blocks from the touch blocks of the touch region, wherein the boundary touch blocks are located at a boundary of the touch region and have a maximum sensing value; and
obtaining the first length and the second length according to a plurality of intervals of the boundary touch blocks.

10. The gesture detecting method capable of filtering panel mistouch as claimed in claim 9, wherein the step of obtaining the first length and the second length according to the intervals of the boundary touch blocks comprises:
obtaining the first length according to a maximum interval of the boundary touch blocks along the first direction, and obtaining the second length according to a maximum interval of the boundary touch blocks along the second direction.

11. The gesture detecting method capable of filtering panel mistouch as claimed in claim 9, wherein the boundary touch blocks comprise:
a first boundary touch block, having a maximum sensing value among the touch blocks located at a boundary side of the touch region along the first direction;
a second boundary touch block, having a maximum sensing value among the touch blocks located at a boundary side of the touch region along the second direction;
a third boundary touch block, having a maximum sensing value among the touch blocks located at another boundary side of the touch region along the first direction; and
a fourth boundary touch block, having a maximum sensing value among the touch blocks located at another boundary side of the touch region along the second direction.

12. The gesture detecting method capable of filtering panel mistouch as claimed in claim 11, wherein the first length is an interval of the first boundary touch block and the third boundary touch block along the first direction, and the second length is an interval of the second boundary touch block and the fourth boundary touch block along the second direction.

13. The gesture detecting method capable of filtering panel mistouch as claimed in claim 1, wherein the step of determining whether the shape of the touch region is substantially the mistouch shape comprises:
obtaining a plurality of boundary touch blocks from the touch blocks of the touch region, wherein the boundary touch blocks are located at a boundary of the touch region and have a maximum sensing value;
determining whether a boundary touch block on any boundary side deviates from a central position of the boundary side; and
determining the shape of the touch region to be the mistouch shape when a determination result of one or a plurality of the boundary sides is affirmative.

14. The gesture detecting method capable of filtering panel mistouch as claimed in claim 13, wherein the step of determining whether the boundary side on any boundary side deviates from the central position of the boundary side comprises:
obtaining a first individual distance between a first reference boundary touch block on a first boundary side of the touch region and a second reference boundary touch block on another boundary side of the touch region;
obtaining a second individual distance between the first reference boundary touch block and a third reference boundary touch block on still another boundary side of the touch region;
determining whether an absolute difference between the first individual distance and the second individual distance is greater than an offset threshold; and
when a determination result is affirmative, determining that the first reference boundary touch block on the first boundary side deviates from the central position.

15. The gesture detecting method capable of filtering panel mistouch as claimed in claim 14, wherein the first reference boundary touch block is located at a boundary side along one of the first direction and the second direction, the second reference boundary touch block and the third reference boundary touch block are respectively located at two boundary sides along another one of the first direction and the second direction, and the first and second individual distances are respectively calculated according to the one of the first direction and the second direction.

16. The gesture detecting method capable of filtering panel mistouch as claimed in claim 14, wherein the boundary touch blocks comprises:
a first boundary touch block, having a maximum sensing value among the touch blocks located at a boundary side of the touch region along the first direction;
a second boundary touch block, having a maximum sensing value among the touch blocks located at a boundary side of the touch region along the second direction;
a third boundary touch block, having a maximum sensing value among the touch blocks located at another boundary side of the touch region along the first direction; and
a fourth boundary touch block, having a maximum sensing value among the touch blocks located at another boundary side of the touch region along the second direction.

17. The gesture detecting method capable of filtering panel mistouch as claimed in claim 16, wherein
when the first boundary touch block serves as the first reference boundary touch block, the second and the fourth boundary touch blocks serve as the second and the third reference boundary touch blocks;
when the second boundary touch block serves as the first reference boundary touch block, the first and the third boundary touch blocks serve as the second and the third reference boundary touch blocks;
when the third boundary touch block serves as the first reference boundary touch block, the second and the fourth boundary touch blocks serve as the second and the third reference boundary touch blocks; and
when the fourth boundary touch block serves as the first reference boundary touch block, the first and the third boundary touch blocks serve as the second and the third reference boundary touch blocks.

18. A gesture detecting method capable of filtering panel mistouch, comprising:
detecting an area of a touch region of a touch event on a touch panel;
determining whether the area of the touch region is greater than a minimum predetermined area value and smaller than a maximum predetermined area value;
determining whether a shape of the touch region is a mistouch shape when a determination result is affirmative;
when the shape of the touch region is determined to be the mistouch shape, a set of touch coordinates corresponding to the touch event being not reported;
determining whether the area of the touch region is greater than the maximum predetermined area value, and reporting the set of touch coordinates corresponding to the touch event when a determination result is affirmative; and
determining whether the area of the touch region is smaller than the minimum predetermined area value, and not reporting the set of touch coordinates corresponding to the touch event when a determination result is affirmative.

19. The gesture detecting method capable of filtering panel mistouch as claimed in claim 18, wherein the step of determining whether the shape of the touch region is the mistouch shape comprises:
obtaining a first length of the shape of the touch region along a first direction and a second length of the shape of the touch region along a second direction; and
determining the shape of the touch region to be the mistouch shape when an absolute difference of the first length and the second length is greater than a predetermined difference value.

20. The gesture detecting method capable of filtering panel mistouch as claimed in claim 19, wherein the step of obtaining the first length and the second length comprises:
obtaining a plurality of boundary touch blocks from the touch blocks of the touch region, wherein the boundary touch blocks are located at a boundary of the touch region and have a maximum sensing value; and
obtaining the first length and the second length according to a plurality of intervals of the boundary touch blocks.

21. The gesture detecting method capable of filtering panel mistouch as claimed in claim 20, wherein the step of obtaining the first length and the second length according to the intervals of the boundary touch blocks comprises:
obtaining the first length according to a maximum interval of the boundary touch blocks along the first direction, and obtaining the second length according to a maximum interval of the boundary touch blocks along the second direction.
